(19) United States
(12) Patent Application Publication
(10) Pub. No.: US 2010/0306351 A1
(43) Pub. Date: Dec. 2, 2010

(54) METHOD AND APPARATUS FOR DOMAIN NAME AUTOCONFIGURATION IN IP-BASED WIRELESS SENSOR NETWORK

(76) Inventors: Eun-Ju Lee, Daejon-city (KR); Jae-Hong Ryu, Daejeon-city (KR); Bong-Soo Kim, Daejeon-city (KR); Cheol-Sig Pyo, Daejeon-city (KR); Jong-Suk Chae, Daejeon-city (KR); Hyung-Seok Kim, Seoul (KR)

Correspondence Address: STAAS & HALSEY LLP, SUITE 700, 1201 NEW YORK AVENUE, N.W., WASHINGTON, DC, 20005, US

(21) Appl. No.: 12/745,746

(22) PCT Filed: Apr. 4, 2008
(86) PCT No.: PCT/KR08/01911

§ 371 Date: Aug. 6, 2010

(30) Foreign Application Priority Data
Dec. 3, 2007 (KR) 10-2007-0124373

(51) Int. Cl. G06F 15/177

(52) U.S. Cl. 709/220

(57) ABSTRACT

A method and apparatus for domain name autoconfiguration in an IP-based wireless sensor network is provided. The method includes: receiving sensor node information including position information for representing an installed position of a sensor node, a type of data to be provided by the sensor node, and an internet address of the sensor node; searching for area information including an administrative address corresponding to the position information of the sensor node; generating a domain name of the sensor node based on a type of the sensed data and the found area information; and binding the generated domain name with an internet address of the sensor node and registering the bound result in a domain name server.

### CROSS-REFERENCE TO RELATED PATENT APPLICATION

This application claims the benefit of Korean Patent Application No. 10-2007-0124373, filed on Dec. 3, 2007, in the Korean Intellectual Property Office, the disclosure of which is incorporated herein in its entirety by reference.

### BACKGROUND OF THE INVENTION

1. Field of the Invention

The present invention relates to a method and apparatus for domain name autoconfiguration in an IP-based wireless sensor network, and more particularly, to a method and apparatus for domain name autoconfiguration capable of enabling a user easily to obtain information on a sensor in a desired area through the Internet in a wireless sensor network and enabling a domain name to be automatically set and registered without additional setting of a network operator.

The present invention is derived from a research project supported by the Information Technology (IT) Research & Development (R&D) program of the Ministry of Information and Communication (MIC) and the Institute for Information Technology Advancement (IITA) [2005-S-038-03, Development of UHF RF-ID and Ubiquitous Networking Technology].

2. Description of the Related Art

A sensor network is defined as a wireless network constructed with sensor nodes having a sensing function, a processing function, and a wireless communication function and sink nodes (referred to as data collection stations, gateways, or base stations). This sensor network may be widely used throughout industry. Typical applications will be described.

First, the sensor network may be used for an unmanned reconnaissance and surveillance system, and a command transmission system in a military area. Second, the sensor network may be used for observation of environmental pollution, a wood fire, and a flood, and environmental evaluation related to cultivation in farmland, in environmental area. Third, in a digital home area, intelligent sensors are installed in illumination devices and windows and used to provide various convenient functions such as a remote control function and a crime prevention function. Fourth, the sensor network may be used to improve automation and control and energy efficiency through building monitoring in an intelligent building area. Fifth, the sensor network may be used for a patient management, a health care, a drug management, a system for the handicapped in a medical area. Finally, the sensor network may be used for management of physical distribution and quality management of products in a physical distribution management and telematics area.

Efforts for extending the sensor network to a network that is accessible through the Internet by allocating IP addresses to sensor nodes according to the IEEE 802.15.4 standard are gradually increased by combining the sensor network with the IP through researches such as current 6LowPAN. Although an IPv6 address is unique for the entire area, because the IPv6 address is represented with a 128-bit number, it is inconvenient for the user to access the sensor node.

In order to solve the difficulty of the use of 128-bit address, a method of employing a domain name service (DNS) in which an individual sensor node uses a conventional domain name like the Internet may be used. However, it is assumed that there are a considerably large number of sensor nodes in a sensor network, in general. In addition, it is difficult to apply unique domain names to the sensor nodes in an aspect of combining the IPv6 having a large number of addresses. It is not suitable to use a form of an existing domain name for the sensor network. Accordingly, a new domain name system is necessary for the sensor network.

It is necessary to set an address of a sensor node by itself similarly to an IPv6 stateless autoconfiguration function without causing inconvenience of recording a large number of domain names in the domain name server (DNS server).

The IPv6 address generation method is largely divided into a manual configuration method similar to a conventional IPv4 address, a stateful address autoconfiguration method, and a stateless autoconfiguration method. The address autoconfiguration function is one of new functions of the IPv6 address system. An IPv6 address is automatically generated for each terminal through the address autoconfiguration function. This is because it is desired to allocate IPv6 addresses to non-PC devices such as sensor nodes having no console or display, in addition to general personal computers (PCs). It is unnecessary for the user to set an IPv6 address because of the IP address autoconfiguration function. It is possible for a network operator to reduce inconvenience of allocating an IP address to each user.

Accordingly, a function of automatically generating a domain name such as the IPv6 address autoconfiguration function is necessary. The automatically set domain name has to be set so that users can easily access the sensor network. The domain name has to simply represent properties and a geographical position of a corresponding sensor. Accordingly, the user has to easily request information provided by the sensor.

### SUMMARY OF THE INVENTION

The present invention provides a method and apparatus for domain name autoconfiguration enabling a user easily to obtain information on a sensor in a desired area through the Internet in a wireless sensor network using an IP address and enabling a domain name to be automatically set and registered without additional setting of a network operator by using the domain name of a new system for simply representing a type and a geographical position of the sensor.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an apparatus for domain name autoconfiguration in an IP-based wireless sensor network system according to an embodiment of the present invention; and

FIG. 2 is a flowchart of a method for domain name autoconfiguration in an IP-based wireless sensor network system according to an embodiment of the present invention.

### DETAILED DESCRIPTION OF THE INVENTION

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. It will be understood by those skilled in the art that various changes in form and details may be made therein without departing from the spirit and scope of the present invention as defined by the appended claims.

Accordingly, functions of various elements shown in the attached drawings including functional blocks represented as processors or similar concepts may be provided by using hardware with a function for performing suitable software in addition to dedicated hardware. When the functions are proved by the processors, the functions may be provided by a single shared processor or a plurality of individual processors. Some of the individual processors may be shared. In addition, terms used for a processor, a control, or similar concepts should not exclusively represent hardware with a function of executing software. It will be understood that the terms represent digital signal processor (DSP) hardware, ROM, RAM, and non-volatile memory for storing software without limitation. Other well-known hardware may be represented by the terms.

The present invention will now be described more fully with reference to the accompanying drawings, in which exemplary embodiments of the invention are shown. In the description of the present invention, if it is determined that a detailed description of commonly-used technologies or structures related to the invention may unnecessarily obscure the subject matter of the invention, the detailed description will be omitted. Hereinafter, the present invention will be described in detail by explaining exemplary embodiments of the invention with reference to the attached drawings.

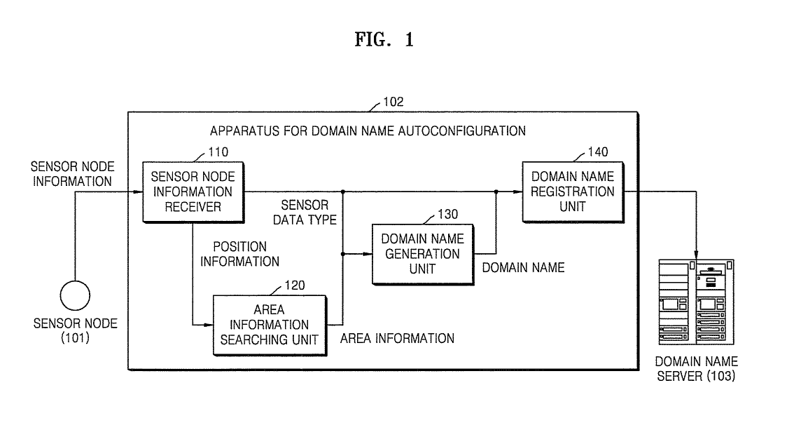

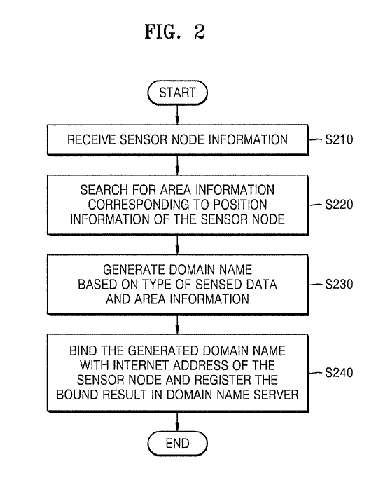

FIG. 1 illustrates an apparatus for domain name autoconfiguration in an IP-based wireless sensor network system according to an embodiment of the present invention. FIG. 2 is a flowchart of a method for domain name autoconfiguration in an IP-based wireless sensor network system according to an embodiment of the present invention.

Referring to FIG. 1, the wireless sensor network system according to the embodiment includes a sensor node 101, an apparatus for domain name autoconfiguration 102, and a domain name server 103.

The sensor node 101 measures a installed position of itself and transmits the installed position to the apparatus for domain name autoconfiguration 102 together with a type of data to be provided by the sensor node 101 and an internet address of the sensor node.

The sensor node 101 can measure a currently installed position of itself through various methods. In the outdoors, it is possible to measure coordinates of a position of the sensor node by using a global positioning system (GPS). In a case where it is difficult to install the GPS or in the indoors, it is possible to measure an approximate position (coordinates) of itself by measuring a received signal strength indication (RSSI) between sensor nodes, a time of arrival (TOA) of a signal, a time difference of arrival (TDOA) of a signal, and an angle of arrival (AOA) of a signal and by using various positioning algorithms such as fingerprinting. In addition, it is possible to measure an accurate position by using a wireless communication medium such as an ultra wideband (UWB) with propagation properties capable of measuring an accurate position.

Specifically, in an IPv6-based wireless sensor network, a sensor node generates an IPv6 address by itself (IPv6 stateless autoconfiguration) and transmits the IPv6 address to the apparatus for domain name autoconfiguration. Accordingly, the IPv6 address and the domain name are set and registered. A synergy achieved by installing a sensor and easily monitoring the sensor through a domain name without efforts of the sensor network operator occurs.

The apparatus for domain name autoconfiguration 102 includes a sensor node information receiving unit 110, an area information searching unit 120, a domain name generation unit 130, and a domain name registration unit 140.

The sensor node information receiving unit 110 receives sensor node information including position information for representing an installed position of the sensor node, a type of data to be provided by the sensor node, and an internet address of the sensor node (operation 210).

The area information searching unit 120 searches for area information including an administrative address corresponding to the position information included in the sensor node information received by the sensor node information receiving unit 110 (operation 220).

The area information searching unit 120 searches for the area information by using at least one of detailed local maps and building plans in which the sensor node is located. That is, the area information is recognized by comparing the installation position represented by the position information included in the sensor node information, the local detailed maps, and the building plans. Here, the administrative address indicates information on the position of the sensor node such as a lot number, a street name, a building name, and a room number, which is easily recognizable and available for a user.

The domain name generation unit 130 generates a domain name of the sensor node based on a type of the sensed data included in the sensor node information received by the sensor node information receiving unit 110 and the area information found by the area information searching unit 120 (operation 230).

The domain name includes an administrative address, a type of the sensed data, and a name for representing a sensor network including the sensor node.

For example, the domain name may be constructed by serially connecting a sensor type name for indicating the type of the sensed data, a sensor position name for indicating for the administrative address, and a network name for indicating a sensor network including the sensor node.

For example, in a case where a temperature sensor node is locate at room 305 of the seventh research building at ETRI in South Korea, the domain name has a form of “temp.7-305.etri.wsn.kr” by combining “temp” that is an abbreviated form of temperature, “7-305.etri”, and “wsn.kr” with one another.

In a case where various types of sensed data are provided by the sensor node located at the aforementioned position, a domain name has a form of “multi.7-305.etri.wsn.kr”.

In addition, in a case where the sensor node is a sink node that gathers data sensed by other sensor nodes, the domain name generation unit 130 generates a domain name based on an area name including sensor nodes belonging to an area managed by the sink node.

For example, in a case where a sensor, which reads sensor values of major areas in Seoul city and averages the sensor values including a sensor value of itself, is located at the top of the City Hall of Seoul, a domain name may have a form of “temp.seoul.korea.wsn.kr”, in addition to “top.seoul.korea.wsn.kr”. Accordingly, it is possible to use necessary data by accessing a sink node or representative gateway that manages the sensor nodes by using an address including a name of an area including sensor nodes such as “http://temp.seoul.korea.wsn.kr” in a case where a user needs not each temperature of each area of Seoul but a mean temperature over Seoul.

The domain name registration unit 140 binds the domain name generated by the domain name generation unit 130 with an internet address of the sensor node included in the sensor node information received by the sensor node information receiving unit 110 and registers the bound result in the domain name server 103 (operation S240).

The domain name server 103 receives the domain name and the internet address of the sensor node from the domain name registration unit 140, binds the domain name with the internet address, and registers the bound result.

The domain name server 103 may be embodied at the same platform as the apparatus for domain name autoconfiguration 102.

According to an embodiment of the present invention, it is possible for a user to easily obtain information on a sensor in a desired area at any place in the world through the Internet. It is also possible for a domain name to be automatically set and registered without additional setting of a network operator through an IPv6 stateless address autoconfiguration function in an IPv6-based wireless sensor network environment.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. The invention can also be embodied as computer readable codes on a computer readable recording medium such as ROM, RAM, CD-ROM, magnetic tapes, hard disks, floppy disks, flash memory, optical data storage devices, and the like which can be read by a computer through a font ROM data structure.

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. An apparatus for domain name autoconfiguration, the apparatus comprising:
a sensor node information receiving unit receiving sensor node information including position information for representing an installed position of a sensor node, a type of data to be provided by the sensor node, and an internet address of the sensor node;
an area information searching unit searching for area information including an administrative address corresponding to the position information of the sensor node;
a domain name generation unit generating a domain name of the sensor node based on a type of the sensed data and the found area information; and
a domain name registration unit binding the generated domain name with an internet address of the sensor node and registering the bound result in a domain name server.

2. The apparatus of claim 1, wherein the sensor node measures the installed position by using a GPS (global positioning system).

3. The apparatus of claim 1, wherein the sensor node measures the installed position by using at least one of an RSSI (received signal strength indication), a TOA (time of arrival), a TDOA (time difference of arrival), and an AOA (angle of arrival).

4. The apparatus of claim 1, wherein the domain name is constructed by serially connecting a sensor type name for indicating the type of the sensed data, a sensor position name for indicating for the administrative address, and a network name for indicating a sensor network including the sensor node.

5. The apparatus of claim 1, wherein the administrative address includes at least one of a lot number, a street name, a building name, and a room number in which the sensor node is located.

6. The apparatus of claim 1, wherein the area information searching unit searches for the area information by using at least one of detailed local maps and building plans in which the sensor node is located.

7. The apparatus of claim 1, wherein in a case where the sensor node is a sink node that gathers data sensed by other sensor nodes, the domain name generation unit generates a domain name based on a name of an area including sensor nodes belonging to an area managed by the sink node.

8. The apparatus of claim 1, wherein an internet address of the sensor node is an IPv6 address that is set through IPv6 stateless address autoconfiguration.

9. A method for domain name autoconfiguration, the method comprising:
receiving sensor node information including position information for representing an installed position of a sensor node, a type of data to be provided by the sensor node, and an internet address of the sensor node;
searching for area information including an administrative address corresponding to the position information of the sensor node;
generating a domain name of the sensor node based on a type of the sensed data and the found area information; and
binding the generated domain name with an internet address of the sensor node and registering the bound result in a domain name server.

10. The method of claim 9, wherein the sensor node measures the installed position by using a GPS (global positioning system).

11. The method of claim 9, wherein the sensor node measures the installed position by using at least one of an RSSI (received signal strength indication), a TOA (time of arrival), a TDOA (time difference of arrival), and an AOA (angle of arrival).

12. The method of claim 9, wherein the domain name is constructed by serially connecting a sensor type name for indicating the type of the sensed data, a sensor position name for indicating for the administrative address, and a network name for indicating a sensor network including the sensor node.

13. The method of claim 9, wherein the administrative address includes at least one of a lot number, a street name, a building name, and a room number in which the sensor node is located.

14. The method of claim 9, wherein in the searching for the area information, the area information is searched for by using at least one of detailed local maps and building plans in which the sensor node is located.

15. The method of claim 9, wherein in a case where the sensor node is a sink node that gathers data sensed by other sensor nodes, the generating of the domain name of the sensor node includes generating a domain name based on a name of an area including sensor nodes belonging to an area managed by the sink node.

16. The method of claim 9, wherein an internet address of the sensor node is an IPv6 address that is set through IPv6 stateless address autoconfiguration.
